(19) United States
(12) Patent Application Publication
(10) Pub. No.: US 2026/0218671 A1
(43) Pub. Date: Jul. 30, 2026

(54) ENGINE AND OPERATING STRATEGY AUGMENTING TUMBLE FLOW TO INCREASE FUEL-AIR MIXING

(71) Applicant: Caterpillar Inc., Peoria, IL (US)

(72) Inventors: Bobby John, Peoria, IL (US); Chad Palmer Koci, Washington, IL (US)

(73) Assignee: Caterpillar Inc., Peoria, IL (US)

(21) Appl. No.: 19/041,173

(22) Filed: Jan. 30, 2025

(51) Int. Cl. F02M 21/02; F02M 21/04; F02M 23/00; F02M 25/03

(52) U.S. Cl. CPC F02M 21/0206; F02M 21/0284; F02M 21/04; F02M 23/00; F02M 25/03

(57) ABSTRACT

Operating an engine includes injecting a first injection containing a gaseous fuel such as gaseous molecular hydrogen into a cylinder, and such that at least some of the gaseous fuel is entrained in a tumbling flow of pressurized air. A second injection containing a fluid including gaseous fuel, air, or water, for example, is injected to augment the tumbling flow so as to increase fuel-air mixing in the cylinder. Related apparatus is also disclosed.

### TECHNICAL FIELD

The present disclosure relates generally to operating an engine, and more particularly to augmenting a tumbling flow of fuel and air in a cylinder so as to increase fuel-air mixing.

### BACKGROUND

Internal combustion engines are well-known and widely used throughout the world for a great many different purposes ranging from operation of a driveline in a vehicle to powering pumps, compressors, and electrical generators. According to conventional practice, a fuel is introduced into a cylinder, ignited, and a controlled combustion reaction of the fuel with air used to drive a piston coupled to a rotatable crankshaft. A wide variety of fuel types have been used in internal combustion engines for nearly two centuries. Traditional liquid fuels such as gasoline and diesel have long been used but have certain perceived shortcomings such as production of various undesired emissions. Gaseous fuel engines operating on gaseous hydrocarbon fuels address some of the emissions challenges associated with liquid fuels.

In recent years, increased interest and engineering resources have been directed at so-called alternative fuels, including gaseous molecular hydrogen and various blends thereof. Operating an internal combustion engine on hydrogen may have certain advantages respecting emissions, including that combustion of hydrogen at least theoretically produces no so-called greenhouse gases or GHG. Hydrogen, however, presents its own challenges and obstacles. Hydrogen has an extremely fast flame speed, and for optimal combustion and controllability hydrogen generally needs to be thoroughly mixed with air in a cylinder. One known hydrogen engine operating strategy is set forth in U.S. Pat. No. 11,891,962B1.

### SUMMARY

In one aspect, a method of operating an engine includes feeding pressurized air into a cylinder in an engine in an intake stroke of a piston, and injecting a first injection containing a gaseous fuel into the cylinder, such that at least some of the gaseous fuel is entrained in a tumbling flow of a pressurized air. The method further includes injecting a second injection containing a fluid into a cylinder, and augmenting the tumbling flow of the pressurized air and entrained gaseous fuel by way of the second injection so as to increase fuel-air mixing in the cylinder.

In another aspect, an engine system includes an engine forming a cylinder, and a piston movable between a top-dead-center (TDC) position and bottom-dead-center (BDC) position in the cylinder. The engine further includes a cylinder head forming an intake port, and an intake valve supported in the cylinder head and movable between an open position and a closed position to admit pressurized air through the intake port into the cylinder. The intake valve and the intake port are oriented to produce a tumbling flow of a pressurized air defining a circulation path in the cylinder. The engine system further includes a first injector supported in the cylinder head and arranged to define a first injection path targeted through the circulation path at an engine timing preceding the BDC position of the piston. The engine system further includes a second injector supported in the cylinder head and arranged to define a second injection path targeted tangentially to the circulation path at a second engine timing succeeding the BDC position of the piston.

In still another aspect, a method of operating an engine includes injecting a gaseous fuel via a first injector supported in a cylinder head into a cylinder in an engine, and closing an intake valve for the cylinder after starting the injection of a gaseous fuel. The method further includes injecting a fluid via a second injector supported in the cylinder head into the cylinder after the closing of the intake valve and after ending the injection of the gaseous fuel. The method still further includes targeting the injection of the fluid based on a flow pattern of the injected gaseous fuel and pressurized air in the cylinder so as to increase fuel-air mixing in the cylinder, and combusting the mixed gaseous fuel and air in the cylinder.

### BRIEF DESCRIPTION OF DRAWINGS

FIG. 1 is a diagrammatic view of an engine system, according to one embodiment;

FIG. 2 is a view of a cylinder head and associated components, according to one embodiment;

FIG. 3 is a diagrammatic view at one stage of operating an engine, according to one embodiment;

FIG. 4 is a diagrammatic view at another stage of operating an engine, according to one embodiment;

FIG. 5 is a diagrammatic view at yet another stage of operating an engine, according to one embodiment;

FIG. 6 is a diagrammatic view at yet another stage of operating an engine, according to one embodiment;

FIG. 7 is a diagrammatic view at yet another stage of operating an engine, according to one embodiment; and

FIG. 8 is a graph showing engine events and states in operating an engine, according to one embodiment.

### DETAILED DESCRIPTION

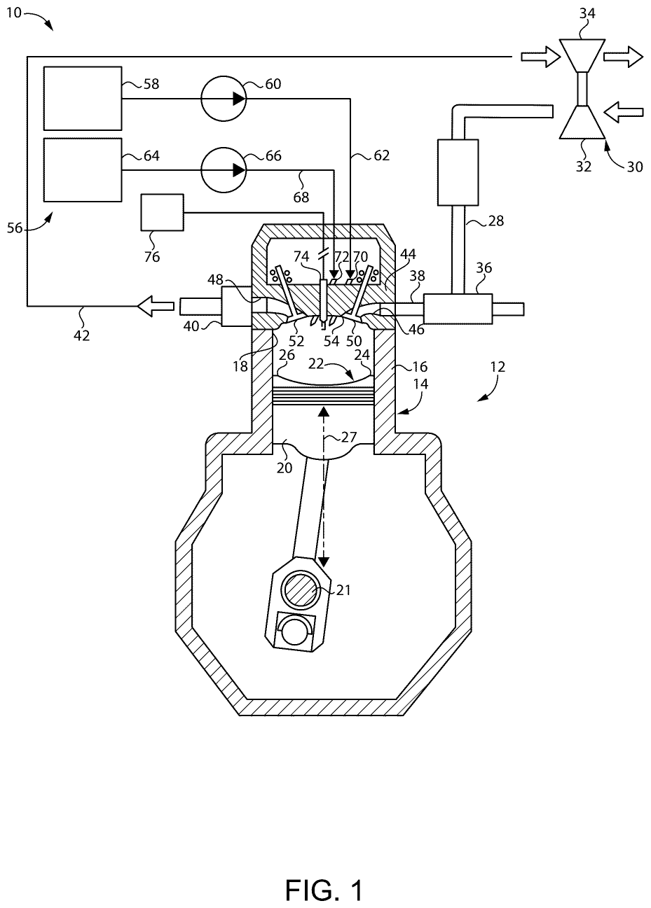

Referring to FIG. 1, there is shown an internal combustion engine system 10, according to one embodiment. Engine system 10 includes an internal combustion engine 12 having an engine housing 14 with a cylinder block 16. Cylinder block 16 forms a cylinder 18 having a piston 20 positioned at least partially therein and movable in a generally conventional manner between a top-dead-center (TDC) position and a bottom-dead-center (BDC) position to rotate a crankshaft 21. Engine system 10 can include a gaseous fuel engine system, as further discussed herein, applicable for any known purpose ranging from operating a driveline in a land vehicle or a marine vessel to operating a pump, a compressor, or an electrical generator to name a few examples. Cylinder 18 may be one of any number of cylinders in engine 12, arranged in any suitable pattern such as an in-line pattern, a V-pattern or in still another arrangement. Each of the cylinders in engine 12 may have an analogously configured piston 20 and other associated hardware, thus the present description of any one component, attribute, or functionality in the singular will be understood to refer by way of example to any other like components, attributes, or functionality of engine system 10.

Piston 20 may include a combustion bowl 22 and a bowl rim 24 extending circumferentially around combustion bowl 22. Piston 20 may also include a bowl edge or bowl edge surface 26 that is positioned just radially inward of bowl rim 24. Combustion bowl 22 may be generally concave or concave having a flat bottom surface, for example. An intake conduit 28 extends to engine 12 to supply a feed of pressurized air into cylinder 18 from a compressor 32 in a turbocharger 30. An intake manifold 36 conveys a feed of pressurized air by way of an intake runner 38 to cylinder 20. Engine system 10 may also include an exhaust manifold 40 structured to feed exhaust from operating engine 12 through an exhaust conduit 42 to a turbine 34 of turbocharger 30.

Engine 12 further includes a cylinder head 34, which may be a pent-roof cylinder head. Pent-roof cylinder head 34 may hemispheric, angular, or another shape having a raised or elevated central portion. Cylinder head 44 forms an intake port 46 extending to cylinder 18, and an exhaust port 48 extending from cylinder 18. A fireside surface 54 illustrating an example pent-roof shape in the form of a dome is shown in FIG. 1. Engine 12 also includes an intake valve 50 supported in cylinder head 44 and movable between an open position and a closed position to admit pressurized air through the intake port 46 into cylinder 18. Engine 12 also includes an exhaust valve 52 supported in cylinder head 44 and movable between an open position and a closed position to expel exhaust through exhaust port 48. Intake valve 50 may be one of two intake valves and exhaust valve 52 may be one of two exhaust valves in a practical implementation strategy. While the present disclosure uses a pent-roof as an example cylinder head configuration capable of use in generating a tumble flow, it should be appreciated that a variety of cylinder head and/or intake valve configurations and arrangements are within the scope of the present disclosure.

Engine system 10 further includes a fuel system 56. Fuel system 56 includes a first supply 58 of a first fluid, a first pump 60, and a first fluid supply conduit 62. Fuel system 56 may also include a second fluid supply 64, a second pump 66, and a second fluid supply conduit 68. In an implementation, first fluid supply 58 includes a first fuel supply containing, for example, a gaseous fuel such as gaseous molecular hydrogen, a gaseous hydrocarbon fuel such as methane, ethane, or natural gas, or various gaseous fuel blends including fuel blends where gaseous molecular hydrogen predominates by volume, although the present disclosure is not thereby limited. A gaseous fuel blend stored in or supplied by first fluid supply 58 might vary in composition. Second fluid supply 64 may also include a second fuel supply also containing a gaseous fuel such as those listed. Second fluid supply 64 might alternatively include water, air, or still another fluid also including various blends.

Fuel system 56 also includes a first injector 70 supported in cylinder head 44, and a second injector 72 supported in cylinder head 44. Engine system 10 may be spark-ignited and includes a sparkplug 74 such as a prechamber sparkplug, an open sparkplug, or even potentially a prechamber ignition device having a spark gap within a prechamber supplied with an ignition fuel via a dedicated supply line. Engine system 10 further includes a controller 76, including any suitable computerized electronic control unit having a processor and a memory, and in control communication with sparkplug 74, first injector 70, second injector 72, and potentially other equipment of engine system 10.

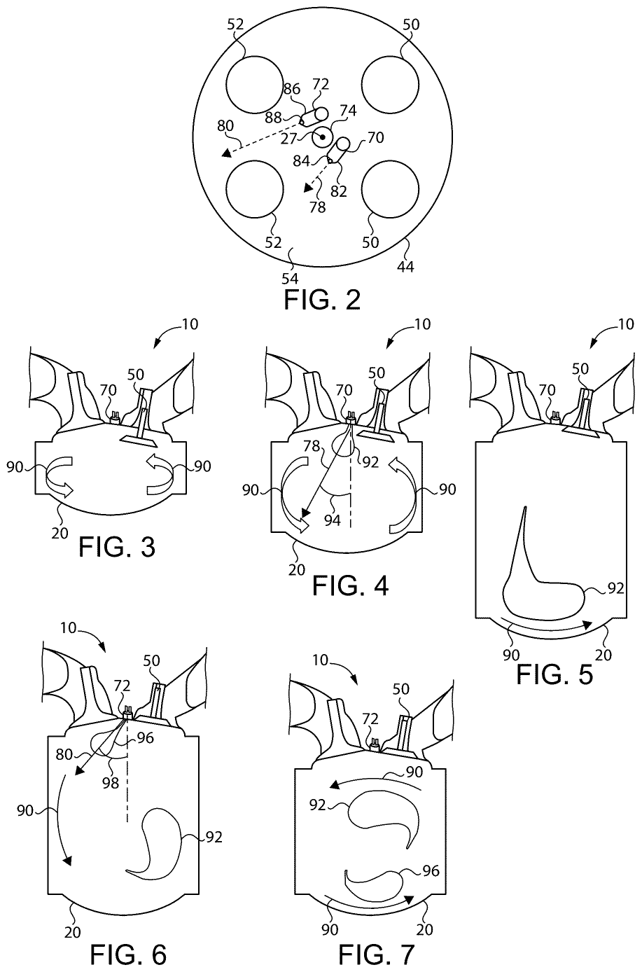

Referring also now to FIG. 2, those skilled in the art will be familiar with tumbling flow or tumble flow in a cylinder wherein fluids within a cylinder experience a circulating pattern of flow that is non-axial. Intake valve 50 and intake port 46 may be oriented to produce a tumbling flow of pressurized air defining a circulation path in cylinder 18. First injector 70 may define a first injection path 78 targeted through the circulation path at an engine timing in an engine cycle preceding a timing at which piston 20 is at the BDC position. Second injector 72 may be arranged to define a second injection path 80 targeted tangentially to the circulation path at a second engine timing in an engine cycle succeeding an engine timing at which piston 20 is at the BDC position.

In an implementation, first injection path 78 targets piston 20. In a refinement, first injection path 78 targets combustion bowl edge 26. By appropriately targeting and timing injections of fuel from first injector 70 and second injector 72, a tumbling flow of pressurized air and entrained gaseous fuel injected in a first injection may be augmented by way of a second injection so as to increase fuel-air mixing in cylinder 18. Also in a practical implementation, first injector 70 includes a nozzle 82 forming a fluid outlet 84, and second injector 72 includes a nozzle 86 forming a second fluid outlet 88. As can be seen from FIG. 2 nozzles 82 and 86 may have different orientations circumferentially around piston center axis 27. First injection path 78 and second injection path 80 may define an angle, circumferentially around piston center axis 27, therebetween. Nozzle 82 and nozzle 86, thus first injection path 78 and second injection path 80, may also have different axial orientations relative to piston center axis 27. The operating principles discussed above and certain of the geometric and structural attributes of engine system 10 will be further apparent by way of subsequent description.

Referring now to FIG. 3, there is shown engine system 10 as it might appear during an intake stroke of piston 20. Intake valve 50 is open, piston 20 is moving downward toward the BDC position, and pressurized air is circulating in a tumbling flow defining a circulation path shown generally by way of arrows 90. At FIG. 4, piston 20 has moved further down closer to the BDC position, intake valve 50 remains open, and a first injection 92 containing a gaseous fuel has started and been injected into cylinder 18. It can further be noted that an angle 94 is defined between injection path 78 and piston center axis 27.

Turning to FIG. 5, piston 20 has moved still further down and is approaching or at the BDC position. First injection 92 containing the gaseous fuel has ended, and has impinged upon and then been redirected by way of combustion bowl edge 26 and begun to move approximately in a tumbling flow circulation pattern. Intake valve 50 remains open.

FIG. 6 depicts engine system 10 just after piston 20 has begun to move from the BDC position toward the TCD position. First injection 92 continues to circulate by way of entrainment in the tumbling flow, however, intake valve 50 is now closed and the tumbling flow has begun to decay rapidly. At this point, a second injection 96 along injection path 80 containing a fluid has started and been injected into cylinder 18. It can be noted that a second angle 98 is defined between injection path 80 and piston center axis 27. Angle 94 and angle 98 may be different. In some instances angle 98 may be smaller than angle 94, and depending upon engine design and operating objectives in other instances angle 98 might be larger than angle 94, or the two angles might be the same.

At this point, with the rapidly decaying tumble flow, the second injection can occur tangentially to the tumbling flow so as to augment the tumbling flow. FIG. 7 shows engine system 10 where the second injection 96 has ended, and begun to stimulate or maintain further tumbling flow, with pockets of fuel from first injection 92 and fluid from second injection 96 tumbling in cylinder 18 and rapidly mixing with the pressurized air. It will be recalled that a fluid injected by way of second injector 72 might be gaseous fuel, but might also be air, or water, for example. It has been discovered that gaseous molecular hydrogen tends to have relatively low momentum, thus adding the momentum of the second injection can assist in maintaining, restoring, or increasing the tumbling flow in a manner that increases fuel-air mixing. At a suitable timing, sparkplug 74 can be energized to ignite the fuel-air mixture and cause combustion of the mixed gaseous fuel and air in cylinder 18.

### INDUSTRIAL APPLICABILITY

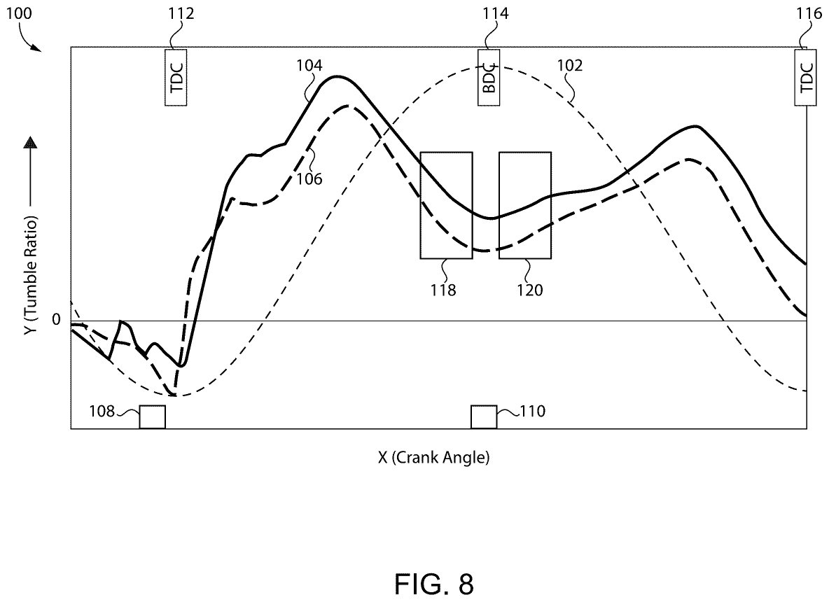

Referring also now to FIG. 8, there is shown a graph 100 illustrating additional events and states that might be observed in an exemplary operation. Crank angle is shown on the X-axis and shows an intake valve opening timing approximately at numeral 108, and an intake valve closing timing at approximately at numeral 110. Tumble ratio is shown on the Y-axis. Numeral 104 shows a tumble ratio that might be observed for an engine system operating at relatively higher RPM, and numeral 106 shows a tumble ratio that might be observed at a relatively lower RPM. Piston position is shown by way of the line identified with numeral 102. A piston TDC position is shown at 112. A piston BDC position is shown at 114. A subsequent piston TDC position is shown at 116.

It can be noted from FIG. 8 that tumble ratio shows an approximate local minimum around the time that the piston is at BDC. Numeral 118 shows a first injection as discussed herein, and numeral 120 shows a second injection as discussed herein. It can further be noted first injection 118 may occur prior to intake valve closing timing 110, thus the intake valve may be closed after starting the injection of the first injection containing the gaseous fuel First injection 118 may be ended prior to or coincident with intake valve closing timing 110. The second injection 120 may occur after, or potentially coincident with, intake valve closing timing 110, and after ending first injection 118. It should be appreciate that some overlap between first injection 118 and second injection 120 as well as some variations respecting the precise ending of first injection 118 and the precise starting of second injection 120 relative to intake valve closing timing 110 are within the scope of the present disclosure.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method of operating an engine comprising:
feeding pressurized air into a cylinder in an engine in an intake stroke of a piston;
injecting a first injection containing a gaseous fuel into the cylinder, such that at least some of the gaseous fuel is entrained in a tumbling flow of the pressurized air;
injecting a second injection containing a fluid into the cylinder; and
augmenting the tumbling flow of the pressurized air and entrained gaseous fuel by way of the second injection so as to increase fuel-air mixing in the cylinder.

2. The method of claim 1 wherein the fluid of the second injection includes a gaseous fuel.

3. The method of claim 2 wherein the gaseous fuel includes gaseous molecular hydrogen.

4. The method of claim 1 wherein the fluid of the second injection includes water or air.

5. The method of claim 1 wherein the first injection is targeted in a first injection path, and the second injection is targeted in a second injection path that is different from the first injection path.

6. The method of claim 5 wherein the first injection path extends from a first fuel injector nozzle and targets a combustion bowl edge of the piston.

7. The method of claim 6 wherein the second injection path extends from a second fuel injector nozzle, and wherein the first injection path and the second injection path define a first angle and a second angle, respectively, relative to a center axis of the piston.

8. The method of claim 1 wherein the injecting the first injection includes starting the first injection prior to an intake valve closing timing, and ending the first injection, and the injecting the second injection includes starting the second injection after the intake valve closing timing and after ending the first injection.

9. The method of claim 1 wherein the engine includes a pent-roof cylinder head, and wherein the augmenting the tumbling flow includes injecting the second injection tangentially to a circulation path of the tumbling flow.

10. An engine system comprising:
an engine forming a cylinder, and including a piston movable between a top-dead-center (TDC) position and a bottom-dead-center (BDC) position in the cylinder;
the engine further including a cylinder head forming an intake port, and an intake valve supported in the cylinder head and movable between an open position and a closed position to admit pressurized air through the intake port into the cylinder;
the intake valve and the intake port being oriented to produce a tumbling flow of the pressurized air defining a circulation path in the cylinder;
a first injector supported in the cylinder head and arranged to define a first injection path targeted through the circulation path at an engine timing preceding the BDC position of the piston; and
a second injector supported in the cylinder head and arranged to define a second injection path targeted tangentially to the circulation path at a second engine timing succeeding the BDC position of the piston.

11. The engine system of claim 10 wherein the first injection path targets the piston.

12. The engine system of claim 11 wherein the piston includes a combustion bowl having a combustion bowl edge, and the first injection path targets the combustion bowl edge.

13. The engine system of claim 10 further comprising a gaseous fuel supply containing a gaseous hydrogen fuel and fluidly connected to the first injector.

14. The engine system of claim 13 further comprising a fluid supply containing water or air and fluidly connected to the second injector.

15. The engine system of claim 10 wherein the first injection path and the second injection path define a first angle and a second, different angle, respectively, relative to a center axis of the piston.

16. The engine system of claim 15 wherein each of the first injector and the second injector includes a total of one fluid outlet to the cylinder.

17. A method of operating an engine comprising:
injecting a gaseous fuel via a first injector supported in a pent-roof cylinder head into a cylinder in an engine;
closing an intake valve for the cylinder after starting the injection of the gaseous fuel;
injecting a fluid via a second injector supported in the pent-roof cylinder head into the cylinder after the closing of the intake valve and after ending the injection of the gaseous fuel;
targeting the injection of the fluid based on a flow pattern of the injected gaseous fuel and pressurized air in the cylinder so as to increase fuel-air mixing in the cylinder; and
combusting the mixed gaseous fuel and air in the cylinder.

18. The method of claim 17 wherein the injection of the gaseous fuel is targeted at a combustion bowl edge of a piston in the cylinder so as to redirect a flow of the gaseous fuel in the cylinder in coordination with a tumbling flow of the pressurized air.

19. The method of claim 18 wherein the targeting of the injection of the fluid includes targeting the fluid in an injection path tangential to a flow pattern circulation path of the injected gaseous fuel and pressurized air.

20. The method of claim 19 wherein the gaseous fuel includes gaseous molecular hydrogen.
